(19) United States
(12) Patent Application Publication
(10) Pub. No.: US 2021/0387230 A1
(43) Pub. Date: Dec. 16, 2021

(54) METHOD FOR DEBONDING DEBONDABLE COATING FILM AND LAMINATE

(71) Applicant: NITTO DENKO CORPORATION, Ibaraki-shi, Osaka (JP)

(72) Inventor: Kazuya FUJIOKA, Ibaraki-shi, Osaka (JP)

(21) Appl. No.: 17/418,299

(22) PCT Filed: Dec. 24, 2019
(86) PCT No.: PCT/JP2019/050570

§ 371 Date: Jun. 25, 2021

(30) Foreign Application Priority Data
Dec. 26, 2018 (JP) 2018-242672

(51) Int. Cl. B05D 5/00; B05D 3/00; B44D 3/16

(52) U.S. Cl. CPC B05D 5/00; B44D 3/16; B05D 3/002

(57) ABSTRACT

The present invention relates to a method for peeling off a strippable coating film formed on a surface of an adherend, including: a first step of preliminarily putting a trigger part in contact with at least a part of the surface of the adherend between the strippable coating film and the adherend; and a second step of peeling off the strippable coating film by using, as a trigger, an interface of the strippable coating film with respect to the trigger part.

### TECHNICAL FIELD

The present invention relates to a method for peeling off a strippable coating film, and a laminate.

### BACKGROUND ART

In the related art, a method for protecting the surface of a structure with an antifouling coating film is used in order to prevent adhesion of dirt and to prevent scratches to the structure.

The antifouling coating film is required to adhere to the structure until a predetermined timing, to protect the surface, and to be easily peeled off if necessary. However, when the antifouling coating film that has been used for many years is repainted, it is necessary to remove the old antifouling coating film. The work of removing the old antifouling coating film causes a heavy labor such as polishing of the antifouling coating film is a high cost.

Therefore, studies on the peeling-off of the coating film have been promoted. For example, Patent Literature 1 describes a coating film that is easily peeled off into a sheet shape and can facilitate the removal work.

In addition, Patent Literature 2 proposes a peeling-off method in which a margin for the peeling-off is allowed to adhere onto a strippable coating film, and the margin for the peeling-off is pulled to peel off the strippable coating film and unnecessary paint deposits deposited on the strippable coating film.

### CITATION LIST

### Patent Literature

Patent Literature 1: JP-A-2018-59084

Patent Literature 2: JP-A-2012-170831

### SUMMARY OF INVENTION

### Technical Problem

The antifouling coating film has a problem that it is difficult to peel off the antifouling coating film when the antifouling coating film is tried to be peeled off. The reason is that the antifouling coating film protects a structure and the structure is used while being protected by the antifouling coating and thus the antifouling coating film has excellent adhesion and durability. The coating film that is easily peeled off into a sheet shape described in Patent Literature 1 has strong adhesion to an adherend, and thus development of a method for peeling off an antifouling coating film that can improve workability has been desired.

Further, according to the peeling-off method described in Patent Literature 2, the strippable film is peeled off by pulling the margin for the peeling-off, and the margin for the peeling-off may come off from the strippable film. Further, it is necessary to allow the margin for the peeling-off and the strippable film to bond to each other with a high adhesive force. This causes a problem that it is complicated to select materials such a tape or an adhesive which allows the margin for the peeling-off and the strippable film to bond to each other.

The present invention has been made in view of the above circumstances, and an object thereof is to provide a method for peeling off a strippable coating film, and a laminate, which can be easily peeled off at a desired timing and are excellent in workability.

### Solution to Problem

That is, one embodiment of the present invention relates to a method for peeling off a strippable coating film formed on a surface of an adherend, comprising: a first step of preliminarily putting a trigger part in contact with at least a part of the surface of the adherend between the strippable coating film and the adherend; and a second step of peeling off the strippable coating film by using, as a trigger, an interface of the strippable coating film with respect to the trigger part.

In a preferable embodiment of the method for peeling off a strippable coating film, the first step may include a step of putting a trigger part on the surface of the adherend, a step of coating a composition for forming a strippable coating film onto the surface of the adherend so as to cover at least a part of the trigger part, and a step of drying the composition for forming a strippable coating film to form the strippable coating film.

In another preferable embodiment of the method for peeling off a strippable coating film, the first step may include a step of coating a composition for forming a strippable coating film onto the surface of the adherend, a step of embedding the trigger part in the composition for forming a strippable coating film such that the adherend and at least a part of the trigger part are in contact with each other, and a step of drying the composition for forming a strippable coating film to form the strippable coating film.

It is preferable that in the method for peeling off a strippable coating film, the trigger part is put while an extension portion is left in the first step.

Further, in the method for peeling off a strippable coating film, an adhesive force between the trigger part and the strippable coating film is preferably smaller than an adhesive force between the adherend and the strippable coating film.

In addition, in the method for peeling off a strippable coating film, an adhesive force between the trigger part and the adherend is preferably smaller than an adhesive force between the strippable coating film and the adherend.

Furthermore, in the method for peeling off a strippable coating film, an adhesive force between the adherend and the trigger part is preferably 20 N/20 mm or less.

The method for peeling off a strippable coating film may further contain a step of removing the trigger part before the second step.

In the method for peeling off a strippable coating film, the strippable coating film preferably contains an elastomer

Another embodiment of the present invention relates to a laminate comprising: an adherend; and a strippable coating film formed on the adherend and the trigger part, wherein a gap is provided in a part between the adherend and the strippable coating film, and the strippable coating film has an end surface reaching the gap from a surface thereof.

Further, another embodiment of the present invention relates to a laminate comprising: an adherend; a trigger part in contact with at least a part of the surface of the adherend; and a strippable coating film formed on the adherend and the trigger part, wherein an adhesive force between the trigger part and the strippable coating film is smaller than an adhesive force between the adherend and the strippable coating film.

### Advantageous Effects of Invention

The present invention allows for providing a method for peeling off a strippable coating film, and a laminate, which can be easily peeled off at a desired timing and can improve the workability of peeling off a coating film into a sheet shape.

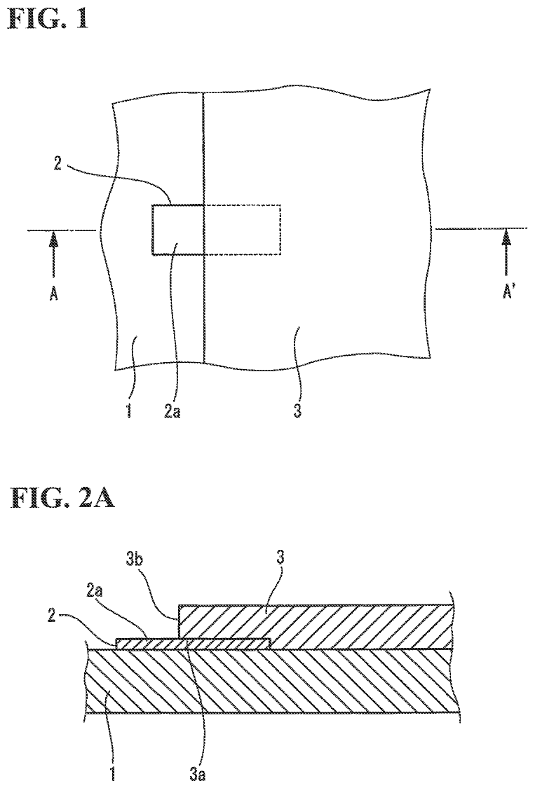

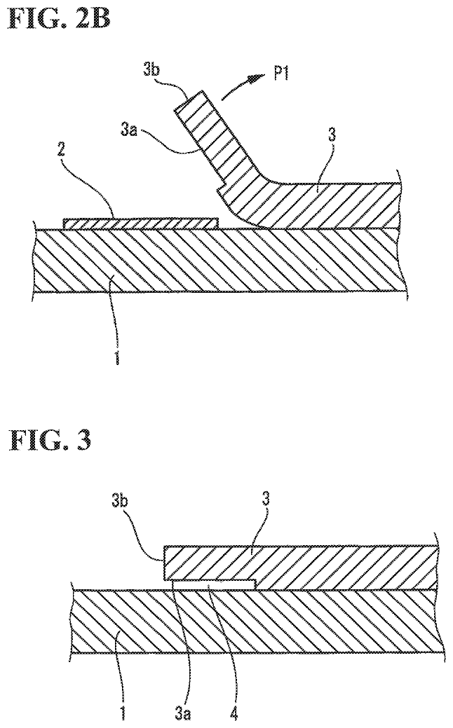

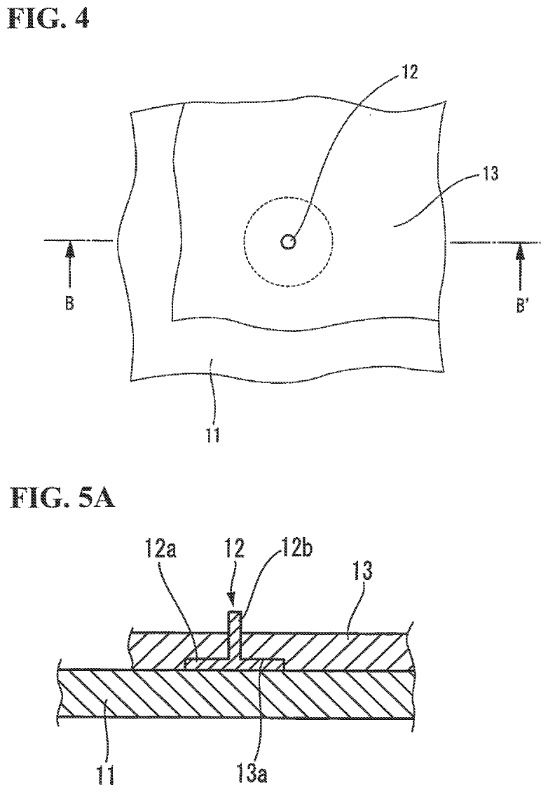

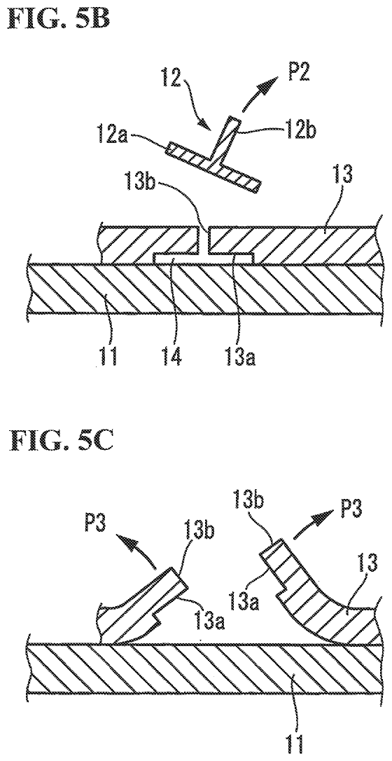

### BRIEF DESCRIPTION OF DRAWINGS

[FIG. 1] FIG. 1 is a top view illustrating a method for peeling off a strippable coating film according to a first embodiment of the present invention.

[FIG. 2A] FIG. 2A is a cross-sectional view taken along a line A-A′ in FIG. 1, illustrating the method for peeling off a strippable coating film in FIG. 1.

[FIG. 2B] FIG. 2B is a cross-sectional view illustrating the method for peeling off a strippable coating film in FIG. 1.

[FIG. 3] FIG. 3 is a cross-sectional view illustrating a method for peeling off a strippable coating film according to a second embodiment of the present invention.

[FIG. 4] FIG. 4 is a top view illustrating a method for peeling off a strippable coating film according to a third embodiment of the present invention.

[FIG. 5A] FIG. 5A is a cross-sectional view taken along a line B-B′ in FIG. 4, illustrating the method for peeling off a strippable coating film in FIG. 4.

[FIG. 5B] FIG. 5B is a cross-sectional view illustrating the method for peeling off a strippable coating film in FIG. 4.

[FIG. 5C] FIG. 5C is a cross-sectional view illustrating the method for peeling off a strippable coating film in FIG. 4.

### DESCRIPTION OF EMBODIMENTS

Hereinafter, embodiments of the present invention will be described in detail. It should be noted that the present invention is not limited to the embodiments described below, and can be optionally changed without departing from the scope of the present invention.

[Method for peeling off Strippable Coating Film]

A method for peeling off a strippable coating film according to an embodiment of the present invention is a method for peeling off a strippable coating film formed on a surface of an adherend, and includes: a first step of preliminarily putting a trigger part in contact with at least a part of the surface of the adherend between the strippable coating film and the adherend; and a second step of peeling off the strippable coating film by using, as a trigger, an interface of the strippable coating film with respect to the trigger part.

Here, the strippable coating film refers to a coating film that can be peeled off into a sheet shape without cracking. The strippable coating film can be formed by coating and drying a composition for forming a strippable coating film, and is strippable into a sheet shape, so that the removal work can be facilitated.

The first step may include a step of putting the trigger part on the surface of the adherend, a step of coating a composition for forming a strippable coating film onto the surface of the adherend so as to cover at least a part of the trigger part, and a step of drying the composition for forming a strippable coating film to form the strippable coating film.

### First Embodiment

FIG. 1 is a top view illustrating a method for peeling off a strippable coating film according to a first embodiment of the present invention. FIG. 2A and FIG. 2B are cross-sectional views illustrating, in order, the method for peeling off a strippable coating film according to the first embodiment of the present invention.

[First Step]

As illustrated in FIG. 1 and FIG. 2A, a trigger part 2 is put on a part of the surface of an adherend 1 (trigger part putting step). The trigger part 2 is a part that creates a trigger for peeling off the strippable coating film to be formed later, is made of, for example, a masking tape, and can be put on a part of the surface of the adherend 1 preliminarily. Thereafter, a composition for forming a strippable coating film is coated using a coating tool such as an air spray gun, a brush, or a roller so as to cover the surface of the adherend 1 and a part of the trigger part 2 (coating step), and then is dried to form a strippable coating film 3 (coating film forming step).

Further, in the first step, the trigger part is preferably put while an extension portion 2a is left. Leaving the extension portion 2a when the trigger part is put makes it easier to remove the trigger part and improves the workability. The extension portion 2a is a portion where the trigger part 2 extends from the strippable coating film. As illustrated in FIG. 1 and FIG. 2A, the extension portion 2a may extend in parallel with the spreading direction of the surface of the adherend. The extending direction is not limited but the extension portion 2a may extend in another direction.

[Second Step]

Thereafter, as illustrated in FIG. 2B, the strippable coating film 3 is peeled off from the adherend 1 by pulling an end surface 3b of the strippable coating film 3 in a direction indicated by an arrow P1.

The peeling-off method of the first embodiment described above allows the strippable coating film 3 to be easily peeled off from the adherend 1 by using, as triggers, the end surface 3b of the strippable coating film 3 and an interface 3a of the strippable coating film 3 with respect to the trigger part 2. In addition, unlike a method for peeling off the trigger part 2 and the strippable coating film 3 at the same time, an adhesive tape, an adhesive or the like that allows the trigger part 2 and the strippable coating film 3 to firmly adhere to each other is not required, and the peeling-off of the trigger part 2 from the strippable coating film 3 allows for preventing the strippable coating film 3 from being hard to be peeled off and preventing the strippable coating film 3 from mixing with foreign matters, so that the work efficiency can be improved. Further, a material having adhesiveness such as a masking tape or sticky note can be used as the trigger part 2, and thus a strippable coating film can be formed by a simple production process at low cost. Furthermore, the present embodiment eliminates the need to remove the trigger part 2 every time the strippable coating film 3 is to be peeled off, and allows for using the same trigger part many times by coating and drying a new strippable coating film composition in the same manner as in the first step. Therefore, the work process can be reduced and the cost of forming the strippable coating film can be reduced as compared with the conventional method.

### Second Embodiment

FIG. 3 illustrates a method for peeling off a strippable coating film according to a second embodiment of the present invention and is a cross-sectional view illustrating a next step to a step illustrated in FIG. 2A. In FIG. 3, same objects as those in FIG. 2A and FIG. 2B are designated by the same reference numerals, and detailed description thereof will be omitted.

In the peeling-off method according to the first embodiment illustrated in FIG. 2A and FIG. 2B, the strippable coating film 3 is peeled off from the adherend 1 without removing the trigger part 2 from the adherend 1. However, in the second embodiment illustrated in FIG. 3, the trigger part 2 is removed before the strippable coating film 3 is peeled off. The second embodiment will be described below.

As illustrated in FIG. 2A, the trigger part 2 is put on a part of the surface of the adherend 1, a composition for forming a strippable coating film is coated using a coating tool such as an air spray gun, a brush, or a roller so as to cover the surface of the adherend 1 and a part of the trigger part 2, and is then dried to form the strippable coating film 3. Thereafter, as illustrated in FIG. 3, the trigger part 2 is removed before the second step, so that a gap 4 is formed between the adherend 1 and the strippable coating film 3. At this time, in the strippable coating film 3, the end surface 3b, which reaches the gap 4 from the surface of the strippable coating film 13, and the surface (interface surface 3a), which has been in contact with the trigger part 2 before the trigger part 2 is removed, forms a trigger for the peeling-off.

Thereafter, in the second step, the strippable coating film 3 is peeled off from the adherend 1 by using, as triggers, the end surface 3b and the interface 3a of the strippable coating film 3. The timing of removing the trigger part 2 is not limited, but may be immediately after the strippable coating film 3 is formed or immediately before the strippable coating film 3 is peeled off from the adherend 1.

The peeling-off method of the second embodiment described above forms the gap 4 between the adherend 1 and the strippable coating film 3, and allows the strippable coating film 3 to be more easily peeled off from the adherend 1 by using, as triggers, the end surface 3b and the interface 3a of the strippable coating film 3. In addition, when the trigger part 2 is removed immediately after the strippable coating film 3 is formed, it is possible to prevent deterioration of the aesthetic appearance due to the exposure of the trigger part 2 even when the structure (adherend 1) is used without peeling off the strippable coating film 3.

In the first and second embodiments, the trigger part 2 is put such that the longitudinal direction of the tape-shaped trigger part 2 is perpendicular to the thickness direction of the strippable coating film 3, but the shape, putting direction and the like of the trigger part 2 are not limited. For example, the trigger part 2 may be put such that the longitudinal direction of the tape-shaped trigger part 2 is parallel to the thickness direction of the strippable coating film 3.

### Third Embodiment

FIG. 4 is a top view illustrating a method for peeling off a strippable coating film according to a third embodiment of the present invention. FIG. 5A to FIG. 5C are cross-sectional views illustrating, in order, the method for peeling off a strippable coating film according to the third embodiment of the present invention.

[First Step]

As illustrated in FIG. 4 and FIG. 5A, a trigger part 12 is put on a part of the surface of an adherend 11, a composition for forming a strippable coating film is coated using a coating tool such as an air spray gun, a brush, or a roller so as to cover the surface of the adherend 11 and a part of the trigger part 12, and is then dried to form a strippable coating film 13. The trigger part 12 is made of, for example, plastic (synthetic resin), and includes a disc-shaped body portion 12a in contact with the surface of the adherend 11 and a rod-shaped protrusion portion 12b formed on the surface of the body portion 12a opposite to the surface in contact with the adherend 11. Thereafter, as illustrated in FIG. 5B, removing the trigger part 12 before the second step forms a gap 14 between the adherend 11 and the strippable coating film 13. At this time, in the strippable coating film 13, an end surface 13b, which reaches the gap 14 from the surface of the strippable coating film 13, and the surface (interface surface 13a), which has been in contact with the trigger part 12 before the trigger part 12 is removed, forms a trigger for the peeling-off.

Thereafter, as illustrated in FIG. 5B, before the second step, the protrusion portion 12b is gripped and the trigger part 12 is removed. When the strippable coating film 13 is made of a flexible material containing, for example, an elastomer, pulling the trigger part 12 in a direction of an arrow P2 deforms the strippable coating film 13, so that the trigger part 12 can be removed. The timing of removing the trigger part 12 is not limited, but may be immediately after the strippable coating film 13 is formed or immediately before the strippable coating film 13 is peeled off from the adherend 11.

Accordingly, the gap 14 is formed between the adherend 11 and the strippable coating film 13, and a hole (end surface 13b) reaching the gap 14 from the surface of the strippable coating film 13 is formed in the strippable coating film 13.

[Second Step]

Thereafter, as illustrated in FIG. 5C, the strippable coating film 13 is peeled off from the adherend 11 by being pulled in the direction indicated by the arrow P2, by using, as triggers, the end surface 13b and the interface 13a of the strippable coating film 13.

Also in the peeling-off method of the third embodiment described above, similar to the second embodiment, the gap 14 is formed at a position where the trigger part 12 has been put between the adherend 11 and the strippable coating film 13, and in the strippable coating film 13, the end surface 13b reaching the gap 14 from the surface of the strippable coating film 13 is formed. Thus, the strippable coating film 13 can be more easily peeled off from the adherend 11 by using the end surface 13b and the interface 13a of the strippable coating film 13. In addition, when the trigger part 12 is removed immediately after the strippable coating film 13 is formed, it is possible to prevent deterioration of the aesthetic appearance due to the exposure of the trigger part 12 even when the structure (adherend 11) is used without peeling off the strippable coating film 13.

In the third embodiment, the trigger part 12 having the disc-shaped body portion 12a and the rod-shaped protrusion portion 12b is put. However, the shapes of the body portion 12a and the protrusion portion 12b are not limited, but trigger parts having various shapes can be used.

### Fourth Embodiment

In a fourth embodiment, the first step in the first to third embodiments may include a step of coating a composition for forming a strippable coating film onto the surface of the adherend, a step of embedding the trigger part in the composition for forming a strippable coating film such that the adherend and at least a part of the trigger part are in contact with each other, and a step of drying the composition for forming a strippable coating film to form the strippable coating film.

As illustrated in FIG. 1, FIG. 2A, FIG. 4, and FIG. 5A, the composition for forming a strippable coating film is coated onto a desired region of the surface of the adherend 1, 11 using a coating tool such as an air spray gun, a brush, or a roller (coating step). Thereafter, the trigger part 2, 12 is embedded between the adherend 1, 11 and the composition for forming a strippable coating film (embedding step). The method of embedding the trigger part 2, 12 is not limited, but a method in which the trigger part 2, 12 are pressed toward the surface of the adherend 1, 11 while grasping the extension portion 2a or the protrusion portion 12b after coating the composition for forming a strippable coating film can be used. The timing of embedding the trigger part 2, 12 may be immediately after the coating of the composition for forming a strippable coating film or during the drying of the composition for forming a strippable coating film as long as the trigger part 2, 12 can be pressed to the position where the trigger part 2, 12 reaches the surface of the adherend 11. The trigger part 2, 12 cannot be embedded in a completely dried state, and thus the composition for forming a strippable coating film is dried to form the strippable coating film 3, 13 after the embedding (coating film forming step).

Thereafter, the strippable coating film 3, 13 is peeled off from the adherend 1, 11 by being pulled, by using, as a trigger, the end surface 3b, 13b and the interface 3a, 13a of the strippable coating film 3, 13.

Similar to the second embodiment or the third embodiment, the peeling-off method according to the fourth embodiment described above may further include a step of removing the trigger part before the second step. In this case, the gap 4, 14 is formed at a position where the trigger part 2, 12 was put between the adherend 1, 11 and the strippable coating film 3, 13, and the end surface 3b, 13b reaching the gap 4, 14 from the surface of the strippable coating film 13 is formed in the strippable coating film 3, 13. Therefore, the strippable coating film 3, 13 can be more easily peeled off from the adherend 1, 11 by using the end surface 3b, 13b and the interface 3a, 13a of the strippable coating film 3, 13. In addition, when the trigger part 2, 12 is removed immediately after the strippable coating film 3, 13 is formed, it is possible to prevent deterioration of the aesthetic appearance due to the exposure of the trigger part 2, 12 even when the structure (adherend 1, 11) is used without peeling off the strippable coating film 3, 13.

Further, the fourth embodiment allows for consideration on the position where the trigger part 2, 12 is disposed, with the size, shape, and coating position of the strippable coating film 3, 13 checked, and the trigger for the peeling-off can be formed at an optimum position. Furthermore, the trigger part 2, 12 is put after the composition for forming a strippable coating film is coated, and thus the trigger part 2, 12 has no risk of being embedded entirely, and the work efficiency of forming the strippable coating film 3, 13 can be improved.

[Laminate]

The present invention also relates to a laminate including an adherend and a strippable coating film formed on the adherend. The laminate according to the embodiment of the present invention will be described below with reference to FIG. 3 and FIG. 5B.

For example, as illustrated in FIG. 3, the laminate includes the gap 4 in a part between the adherend 1 and the strippable coating film 3, and the strippable coating film 3 has the end surface 3b reaching the gap 4 from the surface thereof.

In addition, as illustrated in FIG. 5B, the laminate includes the gap 14 in a part between the adherend 11 and the strippable coating film 13, and the strippable coating film 13 has a hole (end surface 13b) reaching the gap 14 from the surface thereof.

In the laminate configured in this way, similar to the second and third embodiments, a gap is formed between the strippable coating film and the adherend, and an end surface reaching the gap from the surface of the strippable coating film is provided, so that the end surface and the gap allow the strippable coating film to be partially separated from the adherend and work as triggers. As a result, the strippable coating film can be easily peeled off.

Further, the laminate according to the embodiment of the present invention will be described with reference to FIG. 2A and FIG. 5A.

For example, as illustrated in FIG. 2A, the laminate according to the embodiment of the present invention includes the trigger part 2 in contact with the surface of the adherend 1 in a part between the adherend 1 and the strippable coating film 3, and the adhesive force between the trigger part 2 and the strippable coating film 3 is preferably smaller than the adhesive force between the adherend 1 and the strippable coating film 3.

In addition, as illustrated in FIG. 5A, a laminate according to another embodiment of the present invention includes the trigger part 12 in contact with the surface of the adherend 11 in a part between the adherend 11 and the strippable coating film 13. Preferably, the adhesive force between the trigger part 12 and the strippable coating film 13 is smaller than the adhesive force between the adherend 11 and the strippable coating film 13.

In the laminate configured in this way, the trigger part 2 or 12 may be removed before peeling off the strippable coating film 3 or 13 from the adherend 1 or 11, or the strippable coating film may be peeled off without removing the trigger part 2 or 12. In both case, the adhesive force between the adherend and the trigger part is smaller than the adhesive force between the adherend and the strippable coating film, and the adherend and the trigger part are easily separated from each other. Therefore, the strippable coating film can be easily peeled off by using, as a trigger, the interface of the strippable coating film with respect to the trigger part.

Next, the trigger part, the strippable coating film, and the adherend that can be used in the present invention will be described in more detail.

<Trigger Part>

The shape of the trigger part in the present embodiment is not limited, but can be appropriately selected depending on the use of the strippable coating film.

Examples of the shape of the trigger part include a circular shape, a polygonal shape (for example, a triangle, a square, a rectangle, and a polygonal shape having four or more vertices), and a tape shape. The shape may be a combination of these, and may further have protrusions. The trigger part is preferably a rectangular or tape-shaped member.

The trigger part may include only a substrate, or may be provided with an adhesive layer on a part or all of the substrate in order to make it easy to determine the position where the trigger part is put.

The adhesive layer is not limited but may be made of a normal adhesive. For example, various adhesives such as acrylic, urethane-based, polyester-based, silicone-based, and rubber-based adhesives can be used.

In addition, when an adhesive layer is provided on the trigger part, in order to facilitate the removal, a cover such as a film may be put on the surface of the adhesive layer on the extension portion, or the adhesive layer may not be provided on the extension portion.

The substrate of the trigger part in the present embodiment is not limited, but may be cloth, non-woven fabric, paper, resin, metal, or the like, or a combination thereof. The substrate of the trigger part is preferably a resin from the viewpoints of strength and handling. Examples thereof include resins such as polyolefin, polyester, polyamide, polycarbonate, polyphenylene oxide, polyimide, polyamideimide, acrylic resin, polyvinyl chloride, polyvinylidene chloride, and polyacrylonitrile but not limited to these.

The thickness of the substrate of the trigger part in the present embodiment is preferably 10 μm or more, more preferably 20 μm or more, and still more preferably 30 μm or more. The thickness of the substrate is preferably 500 μm or less, more preferably 400 μm or less, and still more preferably 300 μm or less. The thickness of 10 μm or more prevents the trigger part from breaking and makes the handling excellent. The thickness of 500 μm or less makes it easy to remove the trigger part and makes the workability excellent.

The tensile elastic modulus of the substrate of the trigger part is preferably 0.01 GPa or more, more preferably 0.1 GPa or more, and still more preferably 1 GPa or more. The tensile elastic modulus is preferably 300 GPa or less, more preferably 200 GPa or less, and still more preferably 100 GPa or less. A tensile elastic modulus of 0.01 GPa or more is preferred since the trigger part is prevented from breaking, and a tensile elastic modulus of 300 GPa or less is preferred since the workability is excellent.

The tensile elastic modulus of the trigger part can be measured by the method described in Examples.

Preferably, the adhesive force between the trigger part and the strippable coating film is smaller than the adhesive force between the adherend and the strippable coating film. This allows the strippable coating film and the trigger part to be easily separated from each other, and thus the interface of the strippable coating film with respect to the trigger part can trigger peeling off the strippable coating film easily. As a result, the strippable coating film can be easily peeled off at a desired timing, and the workability of peeling off the strippable coating film is improved.

The range of the adhesive force between the trigger part and the strippable coating film can be freely selected depending on the adhesive force between the adherend and the strippable coating film. Preferably, when the adhesive force is 20 N/20 mm or less, the strippable coating film and the trigger part are easily peeled off at the interface therebetween, so that the strippable coating film can be easily peeled off from the adherend by using this interface as a trigger.

The adhesive force is more preferably 15 N/20 mm or less, and still more preferably 10 N/20 mm or less.

The adhesive force of the trigger part can be measured by the method described in Examples.

In addition, the adhesive force between the trigger part and the adherend is preferably smaller than the adhesive force between the strippable coating film and the adherend. This allows the trigger part and the adherend to be easily separated from each other, and thus the trigger part can be easily removed, and the strippable coating film can be easily peeled off from the adherend by using, as a trigger, the gap formed between the adherend and the strippable coating film.

The range of the adhesive force between the trigger part and the adherend can be freely selected depending on the adhesive force between the strippable coating film and the adherend. Preferably, the adhesive force of 20 N/20 mm or less makes it easy to remove the trigger part.

The adhesive force is more preferably 15 N/20 mm or less, and still more preferably 10 N/20 mm or less.

The adhesive force of the trigger part can be measured by the method described in Examples.

<Strippable Coating Film>

The strippable coating film of the present embodiment preferably has a tensile elastic modulus of 0.01 MPa or more. When the tensile elastic modulus of the strippable coating film is 0.01 MPa or more, the strength of the strippable coating film is sufficiently high, and the antifouling effect can be further maintained. In addition, deformation of the strippable coating film due to an external force is prevented. The elastic modulus of the strippable coating film is more preferably 0.05 MPa or more, and still more preferably 0.1 MPa or more. The tensile elastic modulus of the strippable coating film is, for example, 1000 MPa or less from the viewpoint of workability of peeling off the strippable coating film.

The tensile elastic modulus of the strippable coating film can be measured by the method described in Examples.

As the thickness of the strippable coating film, any appropriate thickness can be adapted depending on the use, usage environment, and the like. The thickness of the strippable coating film is preferably 10 μm to 5000 μm. When the thickness of the strippable coating film is 10 μm or more, the strippable coating film is easy to be peeled off without breaking when the strippable coating film is tried to be peeled off. When the thickness of the strippable coating film is 5000 μm or less, the work efficiency of preparing the strippable coating film is excellent.

The thickness of the strippable coating film can be measured using, for example, RI-205 manufactured by PEACOCK.

The adhesive force of a strippable coating film to SUS304 2B shirring finish (hereinafter referred to as SUS) is used as an index showing the difficulty of being peeled off from an adherend when the strippable coating film is used.

The adhesive force of the strippable coating film to SUS according to the present embodiment is preferably 50 N/20 mm or less, preferably 30 N/20 mm or less, still more preferably 20 N/20 mm or less, even more preferably 10 N/20 mm or less, and most preferably 1 N/20 mm or less.

The adhesive force of the strippable coating film can be measured by the method described in Examples.

<Composition for Forming Strippable Coating Film>

A composition for forming the strippable coating film (hereinafter, may be referred to as a strippable coating film forming composition) may contain a resin component and a solvent. As the resin component, for example, elastomers such as a rubber (thermosetting elastomer) and a thermoplastic elastomer can be used. Alternatively, an emulsion or hot melt can be used.

As the rubber, an acrylic rubber, a diene-based rubber, a butyl rubber, a nitrile rubber, a hydrogenated nitrile rubber, a fluorine rubber, a silicone rubber, an ethylene propylene rubber, a chloroprene rubber, a urethane rubber, and an epichlorohydrin rubber can be used. In particular, an acrylic rubber, a diene-based rubber, or a urethane rubber is preferably used. As the diene-based rubber, a natural rubber, an isoprene rubber, a butadiene rubber, a styrene butadiene rubber, a chloroprene rubber, and an acrylonitrile butadiene rubber can be used, and a styrene butadiene rubber is preferably used.

As the thermoplastic elastomer, monovinyl-substituted aromatic compound-based thermoplastic elastomers such as an acrylic thermoplastic elastomer and a styrene-based thermoplastic elastomer can be used.

Examples of the acrylic thermoplastic elastomer include block copolymers of PMMA (polymethylmethacrylate) and an acrylic acid alkyl ester. Examples of the acrylic acid alkyl ester include butyl acrylate, 2-ethylhexyl acrylate, and octyl acrylate. Such a block copolymer can be adjusted within the range of the adhesive force specified in the present invention by changing the ratio of PMMA, which is a hard segment.

As the styrene-based thermoplastic elastomer, for example, SBS (styrene/butadiene/styrene block copolymer), SIS (styrene/isoprene/styrene block copolymer), SEBS (styrene/ethylene/butylene/styrene block copolymer), SEPS (styrene/ethylene/propylene/styrene block copolymer), and SEEPS (styrene/ethylene/ethylene/propylene/styrene block copolymer) can be used.

When the resin component is a styrene-based thermoplastic elastomer, the tensile strength at break and the adhesive force can be adjusted by adjusting the content ratio of styrene in the resin component. The content ratio of styrene is preferably 20 mass % to 40 mass %, more preferably 22 mass % to 35 mass %, and still more preferably 25 mass % to 33 mass %.

The content ratio of the resin component in the composition for forming a strippable coating film is preferably 5 mass % to 95 mass %, more preferably 10 mass % to 90 mass %, still more preferably 15 mass % to 80 mass %, particularly preferably 20 mass % to 70 mass %, and most preferably 25 mass % to 60 mass %.

Examples of the emulsion include a urethane emulsion and an acrylic emulsion.

Examples of the hot melt include an ethylene vinyl acetate resin.

The composition for forming a strippable coating film may contain any suitable other additives as long as the effect of the present invention is not impaired. Examples of such other additives include thickeners (for example, association type, synthetic polymer type, and alkaline thickening type), colorants, ultraviolet absorbers, light stabilizers, antioxidants, defoamers, and fillers.

As the solvent, for example, aromatic hydrocarbons such as benzene, toluene, xylene, ethylbenzene, and trimethylbenzene, aliphatic hydrocarbons such as hexane and heptane, esters such as ethyl acetate and vinyl acetate, ethers such as dioxane and diethyl ether, alcohols such as ethanol, isopropanol and n-butanol, ketones such as acetone, diethyl ketone, and methyl isobutyl ketone, and water can be used. These solvents may be used alone or in combination of two or more thereof.

The content ratio of the solvent in the composition for forming a strippable coating film is preferably 5 mass % to 95 mass %, more preferably 10 mass % to 90 mass %, still more preferably 20 mass % to 85 mass %, particularly preferably 30 mass % to 80 mass %, and most preferably 40 mass % to 75 mass %.

The strippable coating film may be used as an undercoat layer, and an antifouling layer, a rust preventive paint, a hard coat, or the like may be further provided on the strippable coating film.

As the composition for forming the antifouling layer, for example, a silicone-based resin or a fluoropolymer can be used.

The antifouling layer including a hard coat layer may contain any suitable other additives as long as the effect of the present invention is not impaired. Examples of such other additives include ultraviolet absorbers, light stabilizers, and fillers.

The strippable coating film can be formed by coating the composition for forming a strippable coating film onto an adherend and drying the same.

For the coating method, the composition for forming a strippable coating film can be coated directly onto the adherend by a known coating method such as spray, brush coating, roller, curtain flow, roll, dip, and coater.

For a drying method, for example, the composition for forming a strippable coating film can be dried at a temperature of 0° C. to 250° C. (preferably a temperature of room temperature (23° C.) to 180° C., and more preferably a temperature of room temperature (23° C.) to 160° C.) for 2 minutes to 12 hours.

<Adherend>

Examples of a typical material used for the surface of the adherend include gel coat (acrylic polymer/polystyrene, etc.), epoxy resins, enamel (acrylic polymer, etc.), various metals (aluminum, aluminum alloys such as aluminum bronze, stainless steel, and titanium), antifouling paint, polyurethane, polyethylene, polypropylene, polycarbonate, polyethylene terephthalate, polyacetal resins, and ABS resins.

Specific examples of the adherend include various structures such as metal products, woodwork products, plastic products, glass products, buildings (inner and outer walls, floors, and ceilings), electronic equipment, and transportation equipment (for example, vehicles such as automobiles, motorcycles and railroads, and ships).

### EXAMPLES

Hereinafter, the present invention will be specifically described with reference to Examples, but the present invention is not limited to these Examples.

### (Preparation of Composition for Forming Strippable Coating Film)

100 parts by mass of a polyurethane (Superflex 150, manufactured by DKS Co. Ltd.), 0.7 part by mass of a thickener (SN Thickener 660T, manufactured by SAN NOPCO LIMITED), and 1 part by mass of a defoamer (BYK-024, manufactured by Additives & Instruments) were mixed to prepare a composition for forming a strippable coating film. The solid content concentration was about 34 mass %.

### Example 1

A stainless steel (SUS304 2B shirring finish) plate was prepared as an adherend, and a fluorine tape: product name “NITOFLON No. 900UL” (width 10 mm×length 30 mm×thickness 80 μm) manufactured by NITTO DENKO CORPORATION was put as a trigger part on the surface of the stainless steel plate.

The composition for forming a strippable coating film prepared above was coated onto the surface of the adherend to a thickness of about 500 μm using a brush such that at least a part of the trigger part was covered and the trigger part became the end portion of the strippable coating film illustrated in FIG. 2A and FIG. 2B, and was then dried at room temperature (23° C.) to form a strippable coating film.

Then, the strippable coating film was peeled off from the adherend by using the interface of the strippable coating film with respect to the trigger part as a trigger, with the trigger part left, and easiness of the peeling-off was evaluated.

### Example 2

A strippable coating film was formed in the same manner as in Example 1 except that the trigger part was changed to a Si back-treated film: product name “MRF” (width 10 mm×length 30 mm×thickness 38 μm) manufactured by Mitsubishi Chemical Corporation.

Then, the trigger part was removed, the strippable coating film was peeled off from the adherend by using, as a trigger, the gap formed between the adherend and the strippable coating film, and easiness of the peeling-off was evaluated.

### Example 3

A strippable coating film was formed in the same manner as in Example 2 except that the trigger part was changed to a PTFE (polytetrafluoroethylene) film: product name “TEMISH No. 9000UL” (width 10 mm×length 30 mm×thickness 50 μm) manufactured by NITTO DENKO CORPORATION, and was peeled off from the adherend, and easiness of the peeling-off was evaluated.

### Example 4

A stainless steel (SUS304 2B shirring finish) plate was prepared as an adherend, and the composition for forming a strippable coating film prepared above was coated onto the surface of the adherend to a thickness of about 500 μm using a brush.

As a trigger part, a plastic piece: product name “MRF” (width 1 mm×length 30 mm×thickness 50 μm) manufactured by Mitsubishi Chemical Corporation was embedded in the composition for forming a strippable coating film by being pressed toward the surface of the adherend such that the trigger part was the end portion of the strippable coating film illustrated in FIG. 2A and FIG. 2B.

The composition for forming a strippable coating film was dried at room temperature (23° C.) to form a strippable coating film.

Then, the trigger part was removed, the strippable coating film was peeled off from the adherend by using, as a trigger, the gap formed between the adherend and the strippable coating film, and easiness of the peeling-off was evaluated.

### Comparative Example 1

A stainless steel plate (SUS304 2B shirring finish) was prepared as an adherend, and a composition for forming a strippable coating film was coated onto the surface of the stainless steel plate and then dried to form a strippable coating film. Thereafter, the strippable coating film was attempted to be peeled off from the adherend, but could not be peeled off.

(Adhesive Force)

The adhesive forces between the above-described trigger part and the above-described adherend, the above-described trigger part and the above-described strippable coating film, and the above-described adherend and the above-described strippable coating film were measured respectively.

As the adhesive force, forces when the trigger part and the strippable coating film, the adherend and the strippable coating film, and the trigger part and the adherend were peeled off at a peeling angle of 180 degrees and a peeling speed of 300 mm/min were measured using a tensile tester (AUTOGRAPH AGS-J/H, manufactured by Shimadzu Corporation).

(Tensile Elastic Modulus)

The tensile elastic modulus of the trigger part and the strippable coating film was evaluated by using AUTOGRAPH AGS-J/H, manufactured by Shimadzu Corporation, at a tensile speed of 300 mm/min. As the tensile elastic modulus, the maximum tensile elastic modulus at the first rise of the stress-strain curve was adopted.

(Easiness of Peeling off Strippable Coating Film)

The easiness of peeling off the strippable coating film was evaluated according to the following evaluation criteria.

○ (good): the strippable coating film could be easily started to be peeled off from the adherend.

x (poor): it was difficult or impossible to peel off the strippable coating film from the adherend.

Table 1 below shows the kinds and putting methods of the trigger part, the peeling-off methods, and the evaluation results of the adhesive force and the easiness of the peeling-off for Examples and Comparative Example.

TABLE 1

| | | | | | | | | Adhesive | Adhesive | | | |
|---|---|---|---|---|---|---|---|---|---|---|---|---|
| | | | | | | | Adhesive | force | force | | Tensile | |
| | | | | | | Trigger | force | (N/20 mm) | (N/20 mm) | | elastic | |
| | | | | | | when | (N/20 mm) | between | between | Tensile | modulus | |
| | | | Timing | Position | | strippable | between | trigger | adherend | elastic | (N/mm²) | |
| | | | of | of | | coating | trigger | part and | and | modulus | of | Easiness |
| | | | putting | putting | Position | film is | part | strippable | strippable | (N/mm²) | strippable | of |
| | | Trigger | trigger | trigger | start to | peeled | and | coating | coating | of trigger | coating | peeling- |
| | | part | part | part | peel off | off | adherend | film | film | part | film | off |
| Example | 1 | Fluorine | Before | End | Upper | Coating | 5.9 | 0.3 | 27.6 | 124 | 57 | ◯ |
| | | tape | coating | portion | portion of | film | | | | | | |
| | | | | | trigger | | | | | | | |
| | | | | | part | | | | | | | |
| | 2 | Si | Before | End | Trigger | Coating | 0 | 0.05 | 27.6 | 1782 | 57 | ◯ |
| | | back- | coating | portion | formed | film | | | | | | |
| | | treated | | | from | | | | | | | |
| | | film | | | trigger | | | | | | | |
| | | | | | part | | | | | | | |
| | 3 | PTEE | Before | End | Trigger | Coating | 0 | 0.09 | 27.6 | 198 | 57 | ◯ |
| | | film | coating | portion | formed | film | | | | | | |
| | | | | | from | | | | | | | |
| | | | | | trigger | | | | | | | |
| | | | | | part | | | | | | | |
| | 4 | Plastic | During | End | Trigger | Coating | 0 | 0.05 | 27.6 | 1782 | 57 | ◯ |
| | | piece | drying | portion | formed | film | | | | | | |
| | | | | | from | | | | | | | |
| | | | | | trigger | | | | | | | |
| | | | | | part | | | | | | | |
| Comparative | 1 | — | — | — | Coating | — | — | — | 27.6 | — | 57 | X |
| Example | | | | | film | | | | | | | |

In Example 1, the strippable coating film was peeled off from the adherend by using, as a trigger, the interface between the trigger part and the strippable coating film, so that the evaluation result of the easiness of the peeling-off was excellent.

In addition, in Examples 2 to 4, the strippable coating film was peeled off from the adherend by removing the trigger part and using, as a trigger, the gap formed between the adherend and the strippable coating film, so that the evaluation results of the easiness of the peeling-off are excellent.

On the other hand, in Comparative Example 1 in which the trigger part was not put, the peeling-off could not be started because of no trigger for the peeling-off and the evaluation result of the easiness of the peeling-off was poor.

Although preferred embodiments of the present invention have been described above, the present invention is not limited to the above embodiments, and various modifications and substitutions can be added to the above embodiments without departing from the scope of the present invention.

Although the present invention has been described in detail with reference to specific embodiments, it will be apparent to those skilled in the art that various changes and modifications can be made without departing from the spirit and the scope of the present invention.

The present application is based on a Japanese Patent Application No. 2018-242672, filed on Dec. 26, 2018, the contents of which are incorporated herein by reference.

### INDUSTRIAL APPLICABILITY

The present invention allows for providing a method for peeling off a strippable coating film, and a laminate, which can be easily peeled off at a desired timing and can improve the workability of peeling off a coating film into a sheet shape.

### REFERENCE SIGNS LIST

1, 11 adherend

2, 12 trigger part

2a extension portion

3, 13 strippable coating film

3a, 13a interface

3b, 13b end surface

4, 14 gap

12a body portion

12b protrusion portion

1. A method for peeling off a strippable coating film formed on a surface of an adherend, comprising:
a first step of preliminarily putting a trigger part in contact with at least a part of the surface of the adherend between the strippable coating film and the adherend; and
a second step of peeling off the strippable coating film by using, as a trigger, an interface of the strippable coating film with respect to the trigger part.

2. The method for peeling off a strippable coating film according to claim 1, wherein
the first step includes:
a step of putting the trigger part on the surface of the adherend;
a step of coating a composition for forming a strippable coating film onto the surface of the adherend so as to cover at least a part of the trigger part; and
a step of drying the composition for forming a strippable coating film to form the strippable coating film.

3. The method for peeling off a strippable coating film according to claim 1, wherein
the first step includes:
a step of coating a composition for forming a strippable coating film onto the surface of the adherend;
a step of embedding the trigger part in the composition for forming a strippable coating film such that the adherend and at least a part of the trigger part are in contact with each other; and
a step of drying the composition for forming a strippable coating film to form the strippable coating film.

4. The method for peeling off a strippable coating film according to claim 1, wherein the trigger part is put while an extension portion is left in the first step.

5. The method for peeling off a strippable coating film according to claim 1, wherein an adhesive force between the trigger part and the strippable coating film is smaller than an adhesive force between the adherend and the strippable coating film.

6. The method for peeling off a strippable coating film according to claim 5, wherein an adhesive force between the trigger part and the adherend is smaller than an adhesive force between the strippable coating film and the adherend.

7. The method for peeling off a strippable coating film according to claim 1, wherein an adhesive force between the adherend and the trigger part is 20 N/20 mm or less.

8. The method for peeling off a strippable coating film according to claim 1, further comprising:
a step of removing the trigger part before the second step.

9. The method for peeling off a strippable coating film according to claim 1, wherein the strippable coating film contains an elastomer.

10. A laminate comprising:
an adherend; and
a strippable coating film formed on the adherend and a trigger part, wherein
a gap is provided in a part between the adherend and the strippable coating film, and the strippable coating film has an end surface reaching the gap from a surface thereof.

11. A laminate comprising:
an adherend;
a trigger part in contact with at least a part of the surface of the adherend; and
a strippable coating film formed on the adherend and the trigger part, wherein
an adhesive force between the trigger part and the strippable coating film is smaller than an adhesive force between the adherend and the strippable coating film.
